(19) United States
(12) Patent Application Publication
(10) Pub. No.: US 2007/0274771 A1
(43) Pub. Date: Nov. 29, 2007

(54) Supporting apparatus

(75) Inventors: Chien-Chung Chang, Taipei (TW); Yang-Li Fu, Taipei (TW)

Correspondence Address: BIRCH STEWART KOLASCH & BIRCH, PO BOX 747, FALLS CHURCH, VA, 22040-0747, US

(73) Assignee: Chien-Chung Chang

(21) Appl. No.: 11/417,056

(22) Filed: May 4, 2006

(51) Int. Cl. F16B 7/08

(52) U.S. Cl. 403/187

(57) ABSTRACT

A supporting apparatus is provided. A supporting apparatus comprises a positioning plate with a longitudinal tube passing therethrough. A plurality of horizontal connectors engages with and fixes onto the positioning plate. Horizontal connectors are connected to both end of a horizontal tube. Outer surface of each end of the horizontal tube comprises engaging plates with symmetry for engaging with an inclined connector at each end of an inclined tube. The inclined tube and the horizontal tube are engaged on a central line of the horizontal tube so that an eccentric torque is not produced during force distribution. An arc profile and a flat profile on a sidewall of the positioning plate are alternatively arranged so that the tubes are respectively adjustable and taking force equally, such that the supporting apparatus is strong and stable

### BACKGROUND OF THE INVENTION

1. Field of the Invention

The present invention relates in general to an improved supporting apparatus and in particular to a tube supporting apparatus in which tubes are location adjustable and bearing force equally. All forces are applied on the central lines of the tubes so that the eccentric torque is not occurred. The supporting apparatus fastens inclined tubes, horizontal tubes and longitudinal tubes so that the distances between connection joints are fixed. Therefore, the supporting apparatus makes the framework strong and stable.

2. The Prior Arts

FIG. 6 shows a quickly locked supporting apparatus in the prior arts comprising an octagon connecting plate A welded to an outer surface of a longitudinal tube B of the supporting apparatus through a central hole A1. A first lock hole A2 and a second lock hole A3 are alternatively disposed around the connecting plate A for engaging a horizontal connector C. The horizontal connector C is disposed at each end of a horizontal tube D. The horizontal connector C has a slot C1. The slot C1 is disposed at the center of the horizontal connector C, corresponds to the thickness of the connecting plate A, and has an insert hole C2 corresponding to the first and second lock holes A2 and A3 of the connecting plate A. When the connecting plate A engages with the slot C1, the insert hole aligns with the first and second lock holes A2 and A3, so that a pin E is inserted through for fixing. Bending the rear end of the horizontal connector C forms an engaging plate C3. The engaging plate C3 has an engaging hole C31 for engaging with an end of an inclined connector F by a pin F1. The inclined connector F comprises an inclined tube F2 with two ends pressed and a pin F1 perpendicular to the inclined tube F2 for diagonally passing through the engaging hole C31 of the engaging plate C3 of two horizontal connector C.

The conventional supporting apparatus is a rectangle framework with four or more longitudinal tubes and horizontal tubes locked therebetween. A large object is installed on the top of the supporting apparatus. Due to the force distribution, every tube bears force. For firmly supporting the object, an adjustable base is disposed at each end of the supporting apparatus. When taking force, however, eccentric forces are generated because of the conventional inclined tubes are disposed at side edges of the horizontal connectors. When the object at the top of the supporting apparatus applies a horizontal force, the inclined tube is bend, and then the supporting apparatus is deformed and cracked.

Otherwise, the conventional connecting plate is octagonal shaped. The horizontal position tube cannot mount if the supporting apparatus is not rectangle. Thus, the swayed horizontal tube and the lateral force applied horizontally are not adjustable.

### SUMMARY OF THE INVENTION

It is therefore a primary objective of the present invention to provide a supporting apparatus that bearing force equally and may respectively adjust each tube in order to solve the above-mentioned problems.

The present invention provides a supporting apparatus comprising a positioning plate with a longitudinal tube passing therethrough. A first lock hole and a second lock hole are alternatively arranged around the positioning plate for engaging a horizontal connector. The horizontal connector is disposed at each end of a horizontal tube. The horizontal tube has a slot therein that corresponds to the thickness of the positioning plate and has an insert hole. When the positioning plate engages with the slot, the insert hole aligns with the first lock hole, and a pin passes thereby for fixing. An inclined tube is aslope disposed between two parallel horizontal tubes, so that the longitudinal tube, the two parallel horizontal tubes and the inclined tube formed a firm supporting apparatus.

The characterized of the present invention is that a sidewall of the positioning plate corresponding to the first lock hole has a flat profile, a sidewall of the positioning plate corresponding to the second lock hole has an arc profile, the second lock hole is substantially fan-shaped, two inclined connectors are respectively disposed at each end of the inclined tube, and two engaging plates are disposed at each end of the horizontal tube with symmetry for engaging the inclined connectors. The inclined connector has a groove disposed therein and corresponding to the thickness of the engaging plate. The groove has a fixing hole corresponding to an engaging hole of the engaging plate. When the engaging plate engages with the groove of the inclined connector, the fixing hole aligns with the engaging hole so that a pin passes thereby for fixing.

Due to the both ends of the inclined tube of the invention are connected to the engaging plates, which are symmetrical, the force from the inclined tube transfers along the central line of the horizontal tube. Thus an eccentric force and a deforming force are not occurred, such that the supporting apparatus of the invention is strong and firm. Furthermore, the horizontal position tube may enhance the structure of the supporting apparatus of the invention and may be adjustable.

The supporting apparatus of the present invention may be utilized in different environment and varied with demand. It is firm, safe, and reliable than the conventional one. Further, the fabricating process is easy and the building procedure is few. Thus, the supporting apparatus of the invention is convenient, efficient and safe.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an perspective view of a supporting apparatus in accordance with the present invention;

FIG. 2 is a schematic diagram of an inclined tube and a horizontal tube in accordance with the present invention;

FIG. 3 is an assembled diagram of the inclined tube and the horizontal tube in accordance with the present invention;

FIG. 4 is a schematic diagram showing a horizontal position tube to be adjusted according to a positioning plate;

FIG. 5 is an assembled diagram of the supporting apparatus in accordance with the present invention; and

FIG. 6 is a schematic diagram of a supporting apparatus of the prior arts.

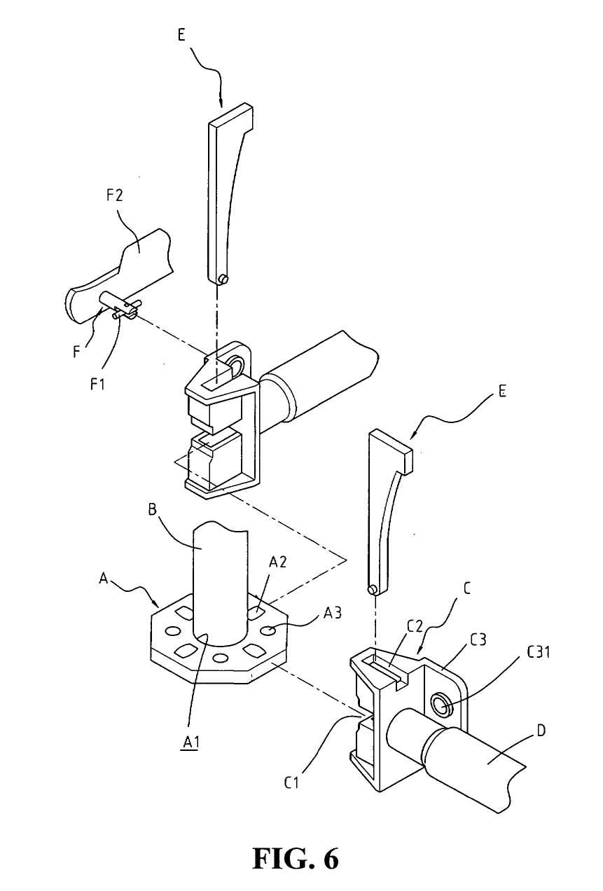

### DETAILED DESCRIPTION OF THE INVENTION

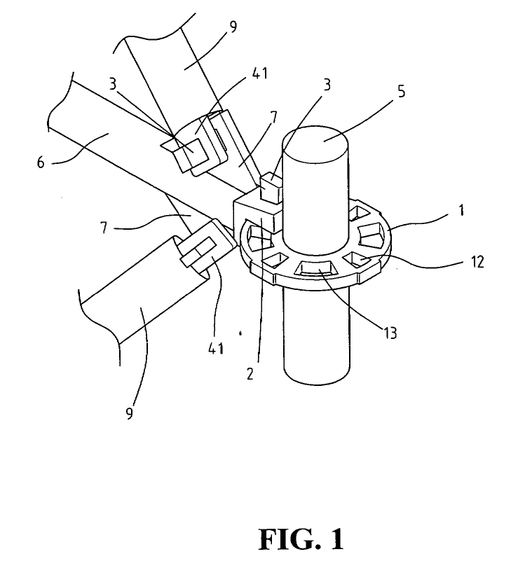

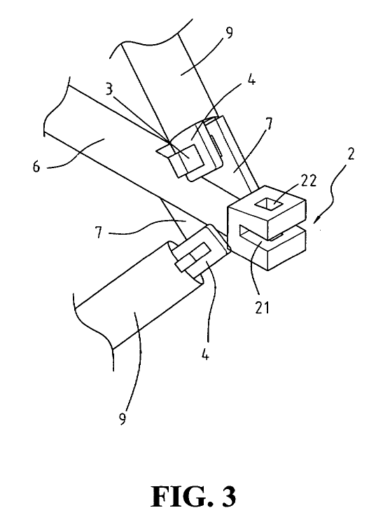

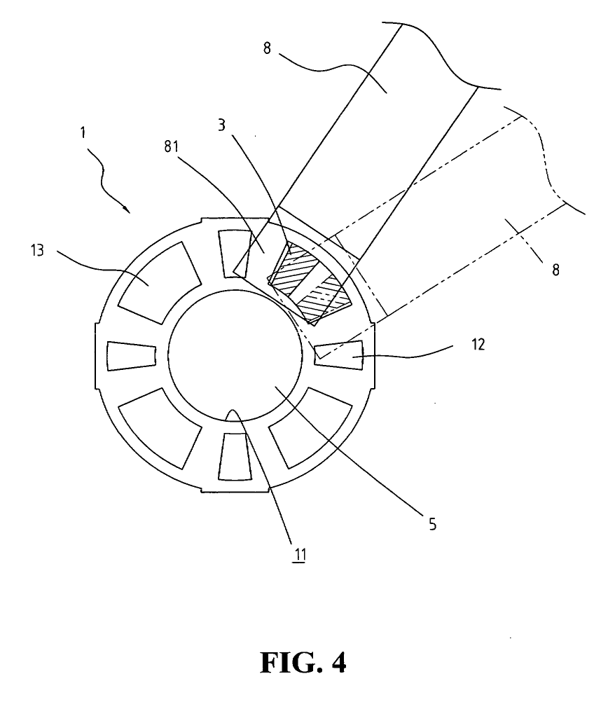

Referring to FIGS. 1 to 4, the supporting apparatus of the present invention comprises a positioning plate 1, a horizontal connector 2, a pin 3 and an inclined connector 4. The positioning plate 1 has substantially circular profile with a central hole 11. The positioning plate 1 is approximately circular. The positioning plate 1 engages with a longitudinal tube 5 via the central hole 11. Several first lock holes 12 and second lock holes 13 are arranged on the positioning plate 1 symmetrically around the longitudinal tube 5. The sidewall of the positioning plate 1 corresponding to the first lock hole 12 has a flat profile. The sidewall of the positioning plate 1 corresponding to the second lock hole 13 has an arc profile. A step is formed between the flat profile and the arc profile. When the positioning plate 1 is fitted into a slot 21 of the horizontal connector 2, the first lock hole 12 aligns with an insert hole 22 on the slot 21 such that a pin passes through the first lock hole 12 and the insert hole 22 to fix the horizontal connector 2 to the positioning plate 1. When a horizontal position tube 8 is required, another pin 3 passes through the second lock hole 13 and the hole on the horizontal position connector 81 such that the horizontal position tube 8 is engaged onto the positioning plate 1.

Referring to FIGS. 1 to 3, two horizontal connectors 2 are connected to two ends of a horizontal tube 6 to engage with two corresponding positioning plates 1 on two longitudinal tubes 5. An outside end of the horizontal connector 2 corresponds to the inside diameter of the horizontal tube 6 such that the horizontal tube 6 is fixed on the horizontal connector 2. The horizontal connector 2 has an approximately U-shaped profile with a slot 21 therein corresponding to the thickness of the positioning plate 1 such that the positioning plate 1 is fixed thereto. The slot 21 is provided with the insert holes 22 corresponding to the first lock hole 12. When the insert holes 22 align with the first lock hole 12, the pin 3 passes therethrough to fix them all. Thus, the horizontal tube 6 is locked and positioned on the positioning plate 1 according to the longitudinal tube 5. The pin 3 is L-shaped for conveniently engaging or separating.

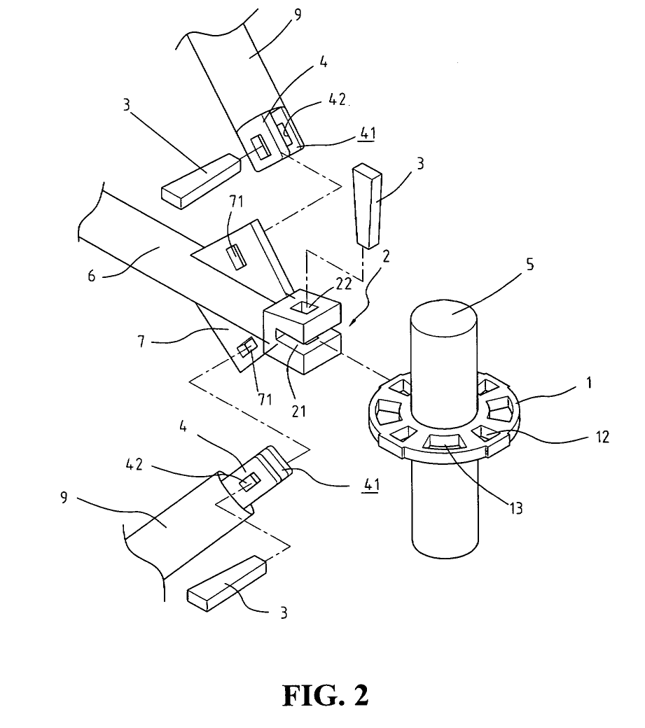

In FIG. 2, a pair of engaging plates 7 is disposed symmetrically on outer surface of each end of the horizontal tube 6. The engaging plate 7 has an engaging hole 71 thereon. Two inclined connectors 4 are connected to two ends of an inclined tube 9. The inclined connector 4 has a groove 41 disposed therein corresponding to the thickness of the engaging plate 7. The groove 41 is provided with fixing holes 42 thereon. When the engaging plate 7 connects to the groove 41 of the inclined connector 4, the fixing holes 42 align with the engaging hole 71 such that a pin 3 can pass through to fix the inclined tube 9 to the horizontal tube 6.

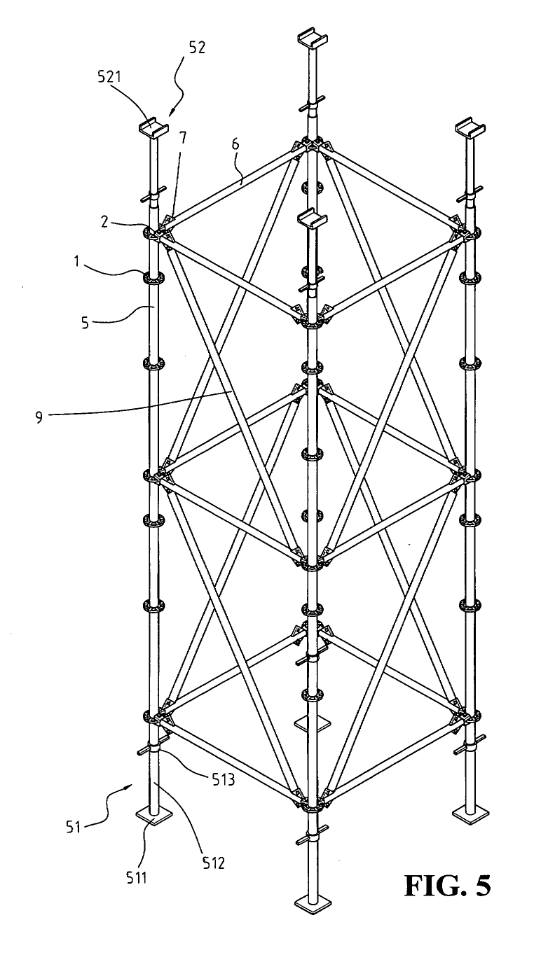

Based on the structure mentioned above, the supporting apparatus of the present invention is assembled as shown in FIG. 5. The height is decided according to numbers of the longitudinal tube 5. Several positioning plates 1 are disposed on the longitudinal tube 5 with predetermined distance. The horizontal tubes 6 are connected to the positioning plates 1 by the horizontal connectors 2 and the horizontal tubes 6 are perpendicular to the longitudinal tubes 5. Thus, a rectangular structure is assembled. Thereafter, the inclined connectors 4 of the inclined tube 9 are connected to the engaging plates 7 of the horizontal tube 6 so that the inclined tube 9 is aslope disposed between two parallel horizontal tubes 6. A lower adjustable set 51 comprises a foundation plate 511 vertically connected a threaded post 512 and a nut 513 with an extending handle such that the lower adjustable set 51 is connected to the bottom of the longitudinal tubes 5 by the nut 513. An upper adjustable set 52 is similar to the lower adjustable set 51 but has a U-shaped body 521 at the top thereof for supporting the objects. The upper adjustable set 52 keeps the object in horizontal state.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A supporting apparatus, comprising a positioning plate having a first lock hole and a second lock hole disposed symmetrically around thereon, a longitudinal tube passing through a center of the positioning plate, a horizontal connector, a horizontal position tube, a horizontal tube, an inclined tube, and a pin,
the first and second lock holes being for engaging the horizontal connector and fixing the horizontal position tube;
the horizontal connector connected to each end of the horizontal tube, having a slot disposed at the center thereof, corresponding to the thickness of the positioning plate, and having insert holes;
the pin passing through the first lock hole and the insert holes while the positioning plate engages with the slot;
the inclined tube aslope disposed between two parallel horizontal tubes, such that the longitudinal tube, the two parallel horizontal tubes and the inclined tube form
a firm supporting apparatus;
wherein the improvements comprises:
a sidewall of the positioning plate corresponding to the first lock hole has a flat profile, and a sidewall of the positioning plate corresponding to the second lock hole has an arc profile;
two inclined connectors are disposed at both ends of the inclined tube; and
a pair of engaging plates is disposed at each end of the horizontal tube for engaging the inclined connector.

2. The supporting apparatus as claimed in claim 1, wherein a step is formed between the flat profile and the arc profile.

3. The supporting apparatus as claimed in claim 1, wherein the second lock hole is approximately fan-shaped.

4. The supporting apparatus as claimed in claim 1, wherein the engaging plate has a engaging hole, and the inclined connector is provided with a groove, which is corresponding to the thickness of the engaging plate, having fixing holes corresponding to the engaging hole, and
wherein a pin passes through the fixing holes and the engaging hole for fixing thereof when the engaging plate engages with the groove of the inclined connector.
